(19) United States
(12) Patent Application Publication
(10) Pub. No.: US 2003/0059570 A1
(43) Pub. Date: Mar. 27, 2003

(54) Corrugated pen holder

(76) Inventor: William Touzani, Houston, TX (US)

Correspondence Address: Loren G. Helmreich, Browning Bushman, PC, Suite 1800, 5718 Westheimer Road, Houston, TX, 77057-5771, US

(21) Appl. No.: 10/051,204

(22) Filed: Jan. 18, 2002

Related U.S. Application Data
(63) Continuation-in-part of application No. 09/961,947, filed on Sep. 25, 2001.

(51) Int. Cl. B32B 3/20; B32B 3/06

(52) U.S. Cl. 428/99; 428/188; 156/256

(57) ABSTRACT

A writing instrument holder may be constructed from a sheet of corrugated plastic, that is cut to the desired configuration and glued, riveted, stitched, or otherwise attached to a mounting surface. The corrugated plastic forms a series of open tubular cells. A selected tubular cell receives the clip of a pen, pencil, or other writing instrument, while the writing instrument hangs by the clip on the outside of the holder.

### RELATED APPLICATION

This application is a continuation in part of U.S. Ser. No. 09/961,947, filed on Sep. 25, 2001, and entitled Corrugated Pen Holder.

### FIELD OF THE INVENTION

The present invention relates to a holder for a plurality of writing instruments, such as pens and/or pencils. More particularly, this invention relates to a relatively low cost writing instrument holder for use in a variety of applications.

### BACKGROUND OF THE INVENTION

A variety of pen holders are available on the market today. Pen holders generally help organize pens, pencils, and other writing instruments, storing them in a convenient location until use of a selected writing instrument is desired.

The prior art discloses a wide-variety of methods for placing and securing a pen holder. U.S. Pat. No. D451,962 discloses a pen holder designed for freestanding desktop placement. U.S. Pat. No. D446,548 discloses a pen holder specifically for use on a cellular telephone. U.S. Pat. No. D442,638 discloses a pen holder mountable using hook and loop fasteners, and No. D441,021 discloses a similar design, mountable using magnetic materials. U.S. Pat. No. 5,718,023 describes a pen holder with a clip for attaching the holder to a belt, waist band, or similar surface. Other examples of pen holders mountable on a dashboard, clothing, and wrist, are disclosed in U.S. Pat. Nos. D354,988, 5,140,723, and D267,555, respectively. Thus, much of the prior art has focused on methods of placing and securing a pen holder for specific uses, activities, or environments.

Pen holders may also have a secondary use as a promotional item. Pens, pencils, and writing instrument holders are among the novelty items frequently circulated at trade shows, conventions, and other business exchanges to promote individual businesses or products. A company name or logo may be imprinted on the cover of a pen holder, and the recipient who displays the pen holder effectively advertises the product to anyone who sees it. U.S. Pat. No. D414,210 discloses an example of a promotional pen holder.

Pen holders all have certain shortcomings, however. Some pen holders are cumbersome, fragile, and/or are non-secured to a variety of supporting surfaces. Other holders are prone to falling from the supporting surface, spilling the writing instruments, or breaking. Others are relatively expensive, offsetting their advantage as a possible promotional item. Some pen holders conceal a portion of the pens, so that leaking or damaged pens may go unnoticed, and may cause a mess when an unsuspecting person retrieves a pen. Other pen holders, such as those resembling open containers, and improvised pen holders such as coffee mugs or jars, require the pen to be supported at its tip, which may damage the tip or create an ink mess inside the container. If a pen is instead stored upside down to protect its tip, the ink may flow away from the tip, rendering the pen temporarily unusable. Pen holders may also be heavy, especially when large and constructed from materials such as metal or glass. The increased weight affects the ability of the pen holder to be stored and transported, and increases cost. Other pen holders are useful only at specific locations or during specific applications.

The disadvantages of the prior art are overcome by the present invention. An improved writing instrument holder is hereinafter provided which may be mounted on various supporting surfaces, may be used individually or in series, and may be marketed with or without one or more writing instruments. The writing instrument holder may be stamped or otherwise cut from a corrugated plastic sheet, so that an individual writing instrument holder may be reliably attached by various mechanisms.

### SUMMARY OF THE INVENTION

The present invention satisfies the need for an improved pen holder. The pen holder may have a low profile and occupy very little space. It may be secured to a surface in almost unlimited positions to prevent accidental spilling. It may be secured in a variety of locations, including but not limited to places pen holders are commonly used. The pen holder may support a pen away from its tip and leave the tip visible to minimize the above problems with open-container and concealing designs. The holder may be extremely light weight, yet virtually indestructible. These superior attributes allow the pen holder to be used in locations and in applications that would otherwise be impractical using prior art pen holders. Finally, the pen holder is relatively inexpensive, and is amenable to displaying shapes and designs, making it ideal for use as a promotional item.

In a preferred embodiment, the pen holder may be formed from a sheet of corrugated plastic or other, similarly shaped, molded cellular material that can be cut to the desired configuration then easily secured to a desired supporting surface, with a series of open cells exposed. The pen may be molded or otherwise formed, although stamping the desired configuration from a corrugated sheet is a low cost and efficient manufacturing method. Each cell of the holder may receive the clip of a pen, pencil, or other writing instrument.

The clip of a pen is generally in the form of a relatively narrow, straight, sticklike member that is generally parallel to the body of the pen, and is either an integral part of the pen or of the pen cap, or is otherwise mounted on the body of the pen or cap. This clip is normally designed to attach the pen to the pocket of a shirt. The clip of a pen is often approximately one inch in length, and can easily penetrate and lodge inside the tubular chamber or cell of a corrugated sheet or a similarly shaped cellular article. The inwardly-directed force provided by the clip against the outer wall of the holder strip will keep the pen securely in place under its own weight. When needed, the pen may be easily accessed by sliding the clip back out of the cell by hand.

Corrugated plastic sheets will likely be the best materials for construction of pen holders in terms of cost, availability, ease of manufacture, and ease of processing. Corrugated plastic sheets are widely available and are used, for example, for indoor and outdoor signs, as support for printed advertising material, or for making packaging containers and boxes. The sheets are available in a variety of thicknesses and dimensions, and are generally made from polypropylene, PVC, or polycarbonate. The sheets are conventionally extruded into a succession of tubular chambers with outer and inner walls which are separated by a series of generally perpendicular wall spacers, thereby forming the tubular chambers or cells.

A sheet of corrugated plastic can be stamped or otherwise cut through the outer and inner walls and across the tubular chambers into individual pieces to create the raw materials used for manufacturing pen holders. An adhesive layer or other attaching member, such as a pliable magnetic strip, may then be applied to the exposed surface of the back wall of each pen holder so the user can stick the penholder to a variety of mounting surfaces. Alternatively, a sheet of corrugated plastic may first be provided with an adhesive layer or other attaching means on the exposed surface of the back wall, and the pen holders may then be stamped or otherwise cut from the plastic sheet to make individual pen holders, each having a desired configuration. The pen holders may then be packaged in piles, flat packages, or rolls. The pen holders may then be glued to desk walls, to a computer monitor, or other surface, or may be stapled to a book cover or otherwise mounted to a supporting surface. Manufacturers of pen holders may include with each pen holder, if desired, a variety of attaching means such as magnets, rivets, glue, or hook-and-loop fasteners, in the same package as the pen holder, providing the consumer with immediate means of storage and display. Pen holders may also be sold with a plurality of pens or other writing instruments.

Other features of the invention will become apparent from the following detailed description of a preferred embodiment which, taken in conjunction with the accompanying drawings, illustrates by way of example the principles of the invention.

### BRIEF DESCRIPTION OF THE DRAWINGS

FIG. 1 shows the writing instrument holder with one writing instrument retained in one of the tubular cells. The clip is fixed to the cap, and a tubular cell receives the clip to retain the writing instrument.

FIG. 2 shows the same writing instrument holder in FIG. 1, with the writing instrument removed to better illustrate the cap with the clip within a cell. A mounting surface is depicted onto which the writing instrument holder may be fixed.

FIG. 3 shows a side view of a writing instrument. The clip is shown fixed to the cap of the writing instrument.

FIGS. 4A-4G depict different embodiments for the attaching member which may be used attached to the writing instrument holder to a mounting surface. FIG. 4A shows an adhesive layer 28 for securing the writing instrument holder to a mounting surface. FIG. 4B shows a hook and loop fastener for securing the writing instrument holder to a mounting surface. FIG. 4C shows a magnetic member for securing the writing instrument holder to a mounting surface. FIG. 4D shows a circular writing instrument holder attached with threaded stitches for securing the writing instrument holder to a mounting surface. FIG. 4E shows a rivet for securing the writing instrument holder to a mounting surface. FIG. 4F shows a pin for securing the writing instrument holder to a mounting surface. FIG. 4G shows a suction cup for securing the holder to a mounting surface.

FIG. 5A shows a circular writing instrument holder secured to a T-shirt using threaded stitches. FIG. 5B is a closeup view of the circular writing instrument as attached in FIG. 5A.

### DETAILED DESCRIPTION OF THE PREFERRED EMBODIMENT

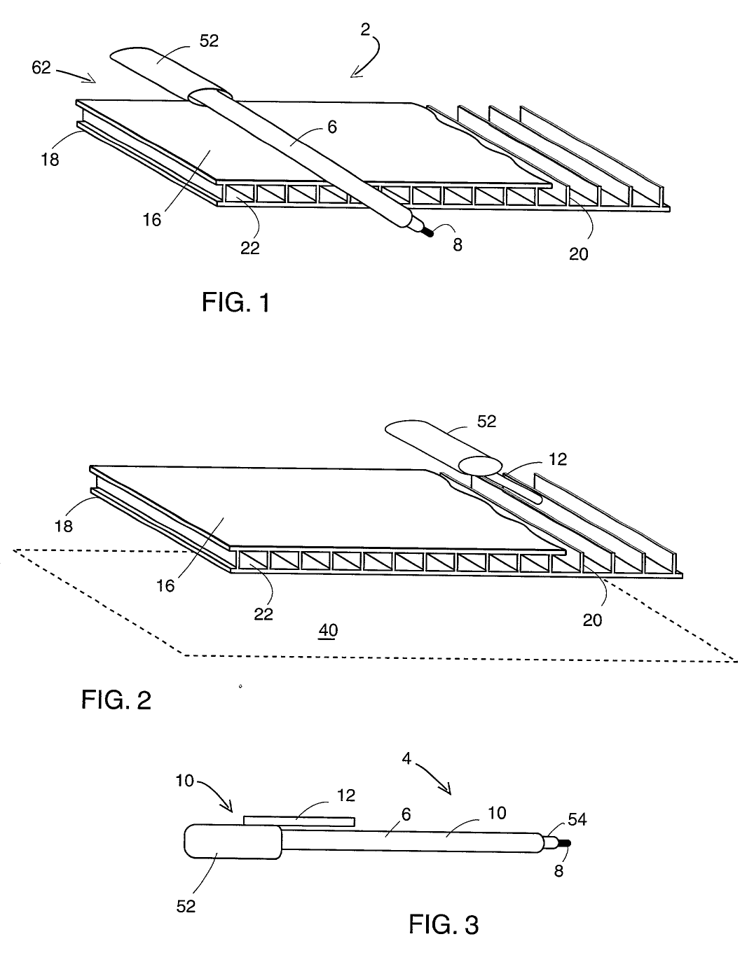

FIGS. 1 and 2 illustrate one embodiment of a writing instrument holder 2 for holding one or more writing instruments 4, such as the writing instrument generally detailed in FIG. 3.

A writing instrument 4 suitable for use with this invention may include a writing instrument body 6, a marking substance 8 such as ink or graphite, a writing end 54 from which the marking substance 6 may be released during marking, and a clip 10 having a straight, elongate member 12 cantilevered from an attachment end 14, which may be used to removably secure the writing instrument 4 to the writing instrument holder 2. The writing instrument may also include a cap 52 removably securable to the writing instrument body 6 for covering the writing end 54 of the writing instrument 4. The clip 10 may be fixed in a conventional manner to either the writing instrument body 6 or the cap 52, and is shown in FIG. 3 fixed to the cap 52.

The writing instrument holder 2 comprises a face wall 16, a back wall 18, and a plurality of wall spacers 20 interconnecting the face wall 16 and the back wall 18, to form more tubular cells 22 each between the face wall 16, the back wall 18, and between adjacent wall spacers 20. The tubular cells 22 preferably are substantially parallel, since the front wall 16 and back wall 18 are preferably substantially parallel. Each tubular cell 22 is thus configured for receiving a clip 10, and the user may removably retain the writing instrument 4 by inserting the clip 10 into the selected tubular cell 22. The writing instrument holder 2 further comprises an attaching member 24 for attaching the writing instrument holder 2 to a selected mounting surface 40, as discussed below.

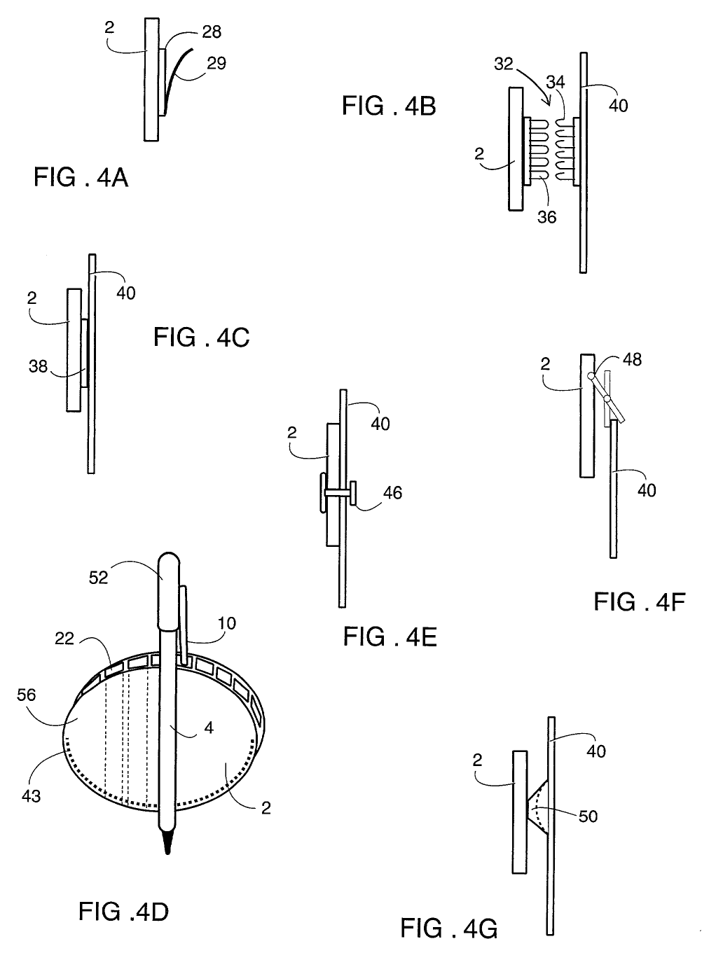

The writing instrument holder is used with an attaching member for conveniently securing the writing instrument holder 2 to the selected mounting surface 40. The attaching member may be an adhesive layer 28 (FIG. 4A), hook and loop fastener 32 having a hook member 34 and a loop member 36 (FIG. 4B), magnetic member 38 (FIG. 4C), a plurality of threaded stitches 42 (FIG. 4D), a rivet 46 (FIG. 4E), or a pin 48 (FIG. 4F). The mounting surface 40 may be any surface against which the back wall 18 may be placed, and which may receive the attaching member. For example, the attaching member 24 may be an adhesive layer 28, and the mounting surface 40 may be a surface on a desktop. The adhesive layer 28 may be placed between the back wall 18 and then against the desktop to secure the writing instrument holder 2 to the desktop.

The writing instrument holder 2 may hold up to as many writing instruments 4 as there are tubular cells 22, with one writing instrument 4 per tubular cell 22. The substantially parallel orientation of the tubular cells 22 allow the writing instruments 4 to be aligned substantially parallel to each other. The wall spacers 20 and the walls 16 and 18 may be relatively thin, such that adjacent tubular cells 22 are in close proximity to each other. The parallel orientation of the cells 22 facilitates placement and retrieval of the writing instrument 4. The close proximity of the writing instruments 4, when retained by the writing instrument holder 2, may help maximize the free space surrounding the writing instrument holder. Use of the writing instrument holder 2 may reduce clutter and increase usable desktop space when used on a desk. Alternatively, use of the writing instrument holder 2 may increase pen access when used on an automobile dashboard.

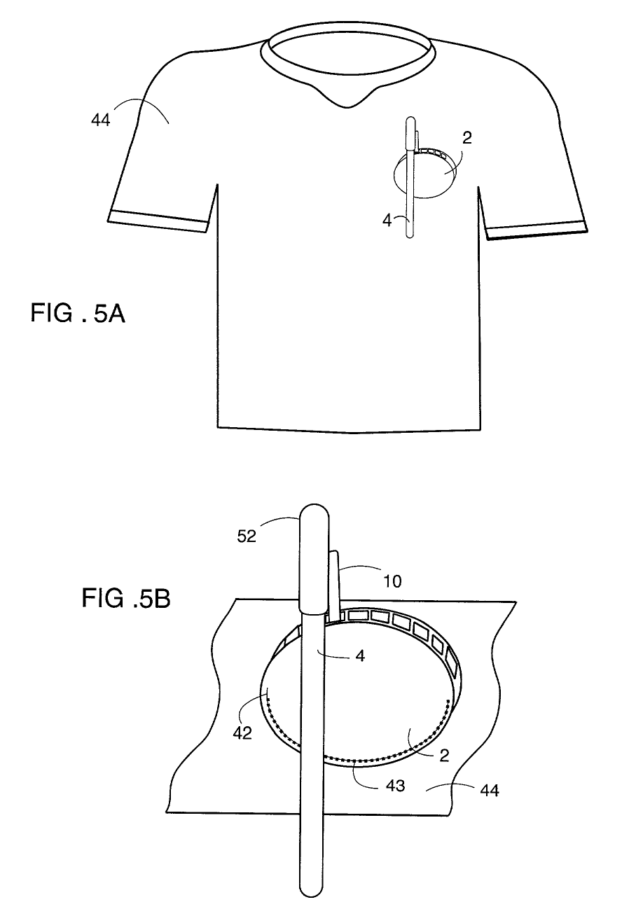

In the preferred embodiment, the writing instrument holder 2 is formed from a corrugated plastic sheet 26. The construction of a corrugated plastic sheet may include the face wall 16, the back wall 18, and the plurality of wall spacers 20 interconnecting the face wall 16 and the back wall 18, forming two or more tubular cells 22 each between the face wall 16, the back wall 18, and between adjacent wall spacers 20. A piece of corrugated plastic sheet may be cut into a desired shape or configuration to produce a corrugated plastic body, such as the generally circular body 56 shown in FIG. 4D, and an attaching member may be used to attach the writing instrument holder 2 to a desired supporting surface. FIGS. 5A and 5B show the corrugated plastic body 56 having a circular shape, while FIGS. 1 and 2 show a generally rectangular configuration for the pen holder. Other configurations, including oval, stepped, and long strip designs and configurations for the holder may be desired. An irregular shaped holder corresponding, for example, to a company logo configuration may be useful for marketing, with the face wall provided with a decal or printed design. The number of tubular cells 22, and thus the number of writing instruments 4 that may be used simultaneously with the writing instrument holder 2, may therefore be governed by the configuration and size of the body cut from the plastic sheet. The corrugated plastic sheet may chosen from a number of different materials such as polypropylene, polyethylene, polyvinylchloride, polyacrylates, polyamides, and polycarbonates.

Referring to FIG. 1 and FIG. 2, a strip of corrugated plastic 62 is cut across its columns of tubular chambers 22 and limited by the front and back walls of the holder. The pen 4 includes body section 6, a cap 52 with an integral clip 10, and writing tip 8. Clip 10 is able to penetrate any of the corrugated chambers along parallel longitudinal axes. Clip 10 and body 6 combine opposing force against flat front wall 16, keeping the pen in position. An adhesive layer 28 may be fixed to the corrugated plastic strip to make it stick to a selected vertical or horizontal mounting surface. Two or more plastic strips or corrugated writing instrument holders with adhesive, such as double sided tape 28, may be stacked on top of each other, with the tape 28 applied to the back wall 18, so that the cover layer 29 may rest directly on the top surface of the front wall of another plastic strip. The layer 29 may then be peeled off before the plastic strip is applied to a mounting surface.

The attaching member may be selected based on the chosen mounting or supporting surface 40. In one embodiment, threaded stitches 42 may be chosen to attach the writing instrument holder 2 to an article of clothing 44, as in FIGS. 5A and 5B. In FIG. 5A, the article of clothing 44 to which the writing instrument holder 2 is attached is a T-shirt. FIG. 5B shows a closeup view of this embodiment. Stitching 42 is thus used to secure the holder to the T-shirt. If desired, small through holes 43 may be stamped into the edges of the body to receive a needle for the stitching 42.

In another embodiment, the writing instrument holder 2 may be attached to a magnetically attractive mounting surface 40 using a magnetic member 38, as shown in FIG. 4C. In this embodiment, the magnetically attractive mounting surface 40 may be a household appliance, such as a refrigerator. The magnetic member 38 may be glued or otherwise attached to the back wall 18 of the writing instrument holder 2.

The writing instrument holder 2 may also be secured to a mounting surface by a hook and loop fastener 32, as shown in FIG. 4B. Hook members 34 can be mounted on an adhesive tape which is secured to the back wall of the body 2. Loop members 36 may be similarly mounted on a supporting surface 40. A large number of hook members and loop members may be mounted on either or both the body 2 or the supporting surface 40 by this hook and loop fastener 32, which in one embodiment may be a VELCRO™ fastener. An advantage of this embodiment is that the writing instrument holder 2 may be easily removed from a mounting surface and reattached to another mounting surface by merely separating the hook and loop fastener.

FIG. 4D shows a writing instrument holder 2 which illustrates in dashed lines the tubular cells 22 which may each receive a clip of a writing instrument. At least a substantial portion of the circumference of the writing instrument holder 2 may be provided with small through punched holes 43 for receiving the needle and stitching to sew the holder 2 to a supporting surface, which may be an article of clothing. Those skilled in the art will appreciate that the thickness of the writing instrument holder 2 may also be reduced along a portion of its periphery to facilitate sewing the holder to a selected article of clothing. The thickness of the corrugated plastic body is not reduced, however, in the area where the exposed cells will receive clips of writing instruments. The holes provided for the stitching may be positioned at any desired location on the holder, so that the user may attach the holder to selected surface, such as an article of clothing, in a manner similar to sewing a button on a shirt.

FIG. 4E shows a writing instrument holder 2 which is secured to a supporting surface 40, which again may be an article of clothing, by a conventional metal rivet 46, such as those commonly used in back packs and jeans. If the position of the writing instrument holder 2 is to remain fixed, two spaced apart rivets 46 may be used to mount the writing instrument holder 2 to the selected supporting surface. An advantage of one rivet 46 is that the writing instrument holder 2 may be rotated about the rivet axis during use, so that the angle or position of the writing instruments may be altered as desired by the user.

FIG. 4F shows yet another embodiment wherein the writing instrument holder 2 with a plurality of clip receiving cells 22 may be attached to a selected mounting surface by a conventional clip 48. Clip 48 may be secured by an adhesive to the back surface of the writing instrument holder 2. The supporting surface, such as the lapel or a shirt pocket, may then be used for supporting the writing instrument by placing the lapel or shirt pocket between the clip 48 and the body 2. FIG. 4G depicts a holder 2 with a suction cup 50 mounted in a conventional manner to the back wall of the holder. The suction cup may be temporarily attached to the surface 40 in a conventional manner. Other attachment members for supporting the holder on a selected mounting surface will be apparent to those skilled in the art.

It may be appreciated that changes to the details of the illustrated embodiments and systems disclosed are possible without departing from the spirit of the invention. While preferred and alternative embodiments of the present invention have been described in detail, it is apparent that further modifications and adaptations of the preferred and alternative embodiments may occur to those skilled in the art. However, it is to be expressly understood that such modifications and adaptations are within the spirit and scope of the present invention, as set forth in the following claims.

What is claimed is:

1. A writing instrument holder for removably retaining one or more writing instruments at selected spatial locations, each of the writing instruments including a writing instrument body housing a marking substance and a clip attached to the writing instrument, the clip having a substantially straight, elongate member cantilevered from an attachment end, the writing instrument holder comprising:
a face wall;
a back wall substantially parallel to the face wall;
a plurality of two wall spacers each interconnecting the face wall and the back wall and forming substantially parallel tubular cells each between the face wall and the back wall and between adjacent wall spacers, each tubular cell configured for receiving the clip to hold the writing instrument in place; and
an attaching member for attaching the writing instrument holder to a selected mounting surface, such that the writing instrument holder is secured to the mounting surface for removably retaining each of the plurality of writing instruments.

2. The writing instrument holder as defined in claim 1, wherein the face wall, the back wall, and the plurality of wall spacers are each formed from a corrugated sheet.

3. The writing instrument holder as defined in claim 2, wherein the corrugated sheet is formed from one or more materials selected from a group consisting of polypropylene, polyethylene, polyvinylchloride, polyacrylates, polyamides, and polycarbonates.

4. The writing instrument holder as defined in claim 2, wherein the writing instrument holder is stamped from a corrugated plastic sheet.

5. The writing instrument holder as defined in claim 1, wherein the back wall, the face wall, and the wall spacers are formed from plastic.

6. The writing instrument holder as defined in claim 1, wherein the attaching member comprises an adhesive layer adhered to the back wall and having an exposed adhesive surface for attaching to the mounting surface.

7. The writing instrument holder as defined in claim 1, wherein the attaching member comprises a hook and loop fastener, the hook and loop fastener including a hook member and a loop member, the hook member securable to one of the writing instrument holder and the mounting surface, and the loop member securable to the other of the writing instrument holder and the mounting surface, the hook member and the loop member being removably securable to each other.

8. The writing instrument holder as defined in claim 1, wherein the attaching member comprises a magnetic member attached to the writing instrument holder and is removably securable to a magnetically attractive mounting surface.

9. The writing instrument holder as defined in claim 1, wherein the attaching member comprises threaded stitching.

10. The writing instrument holder as defined in claim 9, wherein the mounting surface is an article of clothing.

11. The writing instrument holder as defined in claim 1, wherein the attaching member comprises a rivet.

12. The writing instrument holder as defined in claim 1, wherein the attaching member comprises a pin, the pin removably securable to the mounting surface.

13. A writing instrument holder for removably retaining one or more writing instruments at selected spatial locations, each of the writing instruments including a writing instrument body housing a marking substance and a clip attached to the writing instrument, the clip having a substantially straight, elongate member cantilevered from an attachment end, the writing instrument holder comprising:
a plastic body cut from a corrugated plastic sheet, the plastic body having a face wall, a back wall substantially parallel to the face wall, and a plurality of wall spacers each interconnecting the face wall and the back wall, forming substantially parallel tubular cells each between the face wall and the back wall and between adjacent wall spacers, each tubular cell configured for receiving the clip to hold the writing instrument in place; and
an attaching member for attaching the writing instrument holder to a selected mounting surface, such that the writing instrument holder is secured to the mounting surface for removably retaining each of the plurality of writing instruments.

14. The writing instrument holder as defined in claim 13, wherein the corrugated plastic sheet is formed from one or more materials selected from a group consisting of polypropylene, polyethylene, polyvinylchloride, polyacrylates, polyamides, and polycarbonates.

15. The writing instrument holder as defined in claim 13, wherein the attaching member is selected from one or more of a group consisting of an adhesive layer, a hook and loop fastener, a magnetic fastener, a plurality of stitches, a rivet, a pin and a suction cup.

16. A combination of at least one writing instrument and a writing instrument holder for removably retaining a plurality of writing instruments at selected spatial locations,
each of the writing instruments comprising:
a writing instrument body housing a marking substance; and
a clip attached to the writing instrument, the clip having a substantially straight, elongate member cantilevered from an attachment end;
the writing instrument holder comprising:
a face wall;
a back wall substantially parallel to the face wall;
at least two wall spacers each interconnecting the face wall and the back wall and forming substantially parallel tubular cells each between the face wall and the back wall and between adjacent wall spacers, each tubular cell configured for receiving the clip to hold the writing instrument in place; and
an attaching member for attaching the writing instrument holder to a selected mounting surface, such that the writing instrument holder is secured to the mounting surface for removably retaining each of the plurality of writing instruments.

17. The combination as defined in claim 16, wherein the face wall, the back wall, and the plurality of wall spacers are formed from a corrugated plastic sheet.

18. The combination as defined in claim 16, wherein the attaching member is selected from one or more of a group consisting of an adhesive layer, a hook and loop fastener, a magnetic fastener, a plurality of stitches, a rivet, and a pin.

19. The combination as defined in claim 16, wherein:
the writing instrument further comprises a cap for covering a writing end of the writing instrument; and
the clip is secured to the cap.

20. The combination as defined in claim 16, the clip having a contacting member supported on the straight elongate member spaced apart from the attachment end, contacting such that when the clip is inside one of the tubular cells, the face wall is pinched between the contacting member and the writing instrument body.

21. A method of removably retaining each of a plurality of writing instruments at a selected spatial location, each of the writing instruments including a writing instrument body housing a marking substance and a clip attached to the writing instrument, the clip having a substantially straight, elongate member cantilevered from an attachment end, the method of retaining the writing instruments comprising:
cutting a plastic body of a desired configuration from a corrugated plastic sheet, the plastic body having a face wall, a back wall substantially parallel to the face wall, a plurality of wall spacers each interconnecting the face wall and the back wall, forming a plurality of substantially parallel tubular cells each between the face wall and the back wall and between adjacent wall spacers;
fixing an attaching member to the plastic body;
removably attaching the plastic body to a selected mounting surface via the attaching member; and
inserting the clip of each writing instrument into a selected tubular cell.

22. The method as defined in claim 21, the clip having a contacting member supported on the elongate member spaced from the attachment end, such that when the clip is inside a selected tubular cell, the face wall is pinched between the contacting member and the writing instrument body.

23. The method as defined in claim 21, wherein the plastic body is stamped from the corrugated plastic sheet.
